(19) United States
(12) Patent Application Publication
(10) Pub. No.: US 2017/0075668 A1
(43) Pub. Date: Mar. 16, 2017

(54) Methods and Systems for Generating Client-Server Applications for Target Devices

(71) Applicant: Thomas M. Selvi, Berkeley, CA (US)

(72) Inventor: Thomas M. Selvi, Berkeley, CA (US)

(21) Appl. No.: 15/265,748

(22) Filed: Sep. 14, 2016

Related U.S. Application Data
(60) Provisional application No. 62/218,565, filed on Sep. 14, 2015.

(51) Int. Cl. G06F 9/45

(52) U.S. Cl. CPC G06F 8/447; G06F 8/42; H04L 67/10

(57) ABSTRACT

An input source is received by a compiler. The input source includes an abstraction of communication protocols between a plurality of output sources. The input source is compiled into a plurality of output sources by the compiler. At least one of the plurality of output sources includes communication protocols for communicating with at least one other output source. A first output source of the plurality of output sources is provided to a remote machine to be executed.

### CLAIM OF PRIORITY

This application claims priority under 35 U.S.C. 119(e) to U.S. Provisional Patent Application No. 62/218,565, filed Sep. 14, 2015, the disclosure of which is incorporated herein by reference in its entirety.

### BACKGROUND

Web applications are becoming more popular to widespread consumers. With the number of web applications increasing, navigating multiple communication protocols used by different applications has become more complicated. This can make it difficult for seasoned web developers to develop interactive web applications that can be accessed by multiple platforms.

When developers create web applications, considerable work is required to ensure that different communication protocols are correctly implemented. To achieve this, developers must separately compile code for a server, client and other machines that will communicate as part of the application and separately make sure that they will comply with the appropriate communication protocols. This process is time consuming and requires knowledge of numerous protocols used by different machine platforms. Also, creating individual programs as part of a web application separately leaves a greater chance of creating errors in the overall communication between those programs. There is a need in the art for an efficient method for creating web applications that reduces the effort required to create multiple sources and improves the likelihood of compatibility between the sources. It is within this context that the present invention arises.

### SUMMARY

In an example embodiment, a method is disclosed for compiling a program. The method includes receiving an input source by a compiler. The input source includes an abstraction of communication protocols between a plurality of output sources. The method also includes compiling the input source into a plurality of output sources by the compiler. At least one of the plurality of output sources includes communication protocols for communicating with at least one other output source. The method also includes providing a first output source of the plurality of output sources to a remote machine to be executed.

In an example embodiment, a non-transitory computer readable storage medium having embodied thereon a program is disclosed. The program is executable by a processor to perform a method for compiling a program. The method includes receiving an input source by the compiler. The input source includes an abstraction of communication protocols between a plurality of output sources. The method also includes compiling the input source into a plurality of output sources. At least one of the plurality of output sources includes communication protocols for communicating with at least one other output source. The method also includes providing a first output source of the plurality of output sources to a remote machine to be executed.

In an example embodiment, a computing device is disclosed for compiling a program. The computing device includes a processor, a memory, and a compiler engine stored in the memory and executable by the processor to receive an input source. The input source includes an abstraction of communication protocols between a plurality of output sources. The compiler engine is also executable by the processor to compile the input source into a plurality of output sources. At least one of the plurality of output sources includes communication protocols for communicating with at least one other output source. The compiler engine is also executable by the processor to provide a first output source of the plurality of output sources to a remote machine to be executed.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 shows a flowchart of a source code compilation process, in accordance with various embodiments of the present invention.

FIG. 2 shows a flowchart of the lexical analysis operation, in accordance with various embodiments of the present invention.

FIG. 3 shows an example of the dependency analysis, in accordance with some embodiments of the present invention.

FIG. 4 shows an example dependency tree layout, in accordance with some embodiments of the present invention.

FIG. 5 shows a flowchart of the route analysis, in accordance with various embodiments of the present invention.

FIG. 6 shows a flowchart of the sensitive data protection analysis, in accordance with various embodiments of the present invention.

FIG. 7 shows an example of native language (Space code), in accordance with various embodiments of the present invention.

FIG. 8 illustrates a block diagram of a system for compiling code into multiple lower level sources, in accordance with various embodiments of the present invention.

FIG. 9 illustrates a block diagram of a compiler, in accordance with various embodiments of the present invention.

FIG. 10 illustrates a block diagram of a compiling process utilizing communication protocol abstraction constructs, in accordance with various embodiments of the present invention.

FIG. 11 illustrates a method for compiling code into multiple lower level sources, in accordance with various embodiments of the present invention.

FIG. 12 illustrates a method for compiling code from an input having communication protocol abstraction constructs, in accordance with various embodiments of the present invention.

FIG. 13 is a block diagram of an exemplary system for implementing a computing device, in accordance with various embodiments of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

A source code compilation technique is disclosed herein in which a source program written in a native programming language describing a relationship between a plurality of client and server machines is understood and processed to produce a plurality of client and server applications for a plurality of target devices. The source program includes a plurality of semantic objects written in the native programming language concerning:
which clients and/or server machines a section of source code is intended to affect,
which clients and/or server machines a set of data or processes, described within a section of source code, may be used by at runtime,
a section of internal source code to be analyzed and executed by a subset of target devices, and in some cases exclusively by the subset of target devices, and
a section of external source code to be executed by a subset of target devices, and in some cases exclusively by the subset of target devices.

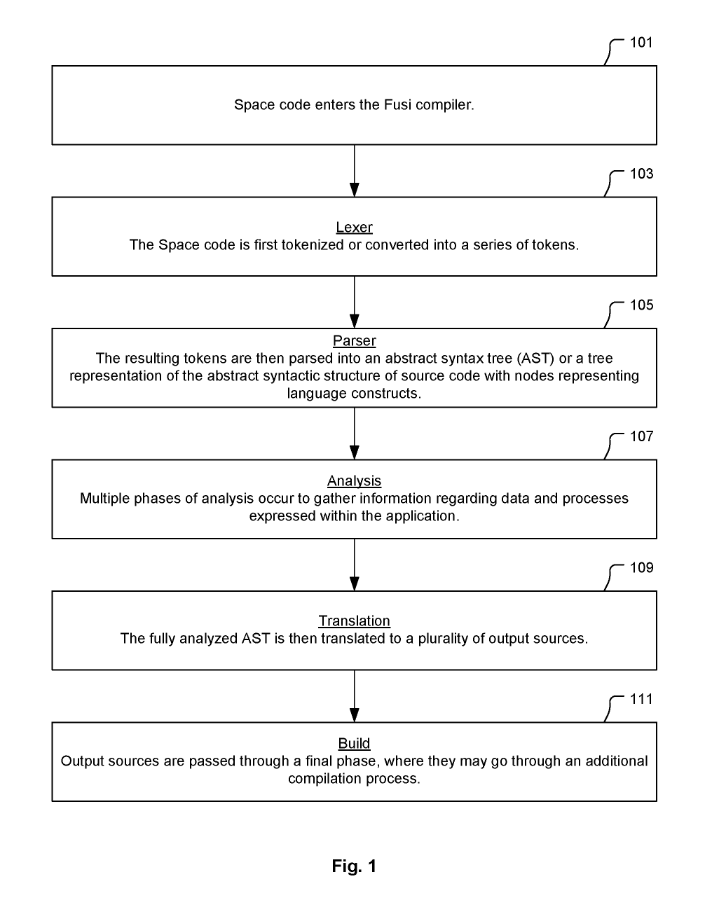

FIG. 1 shows a flowchart of a source code compilation process, in accordance with various embodiments of the present invention. Within the compilation process, a source stream corresponds to a string of characters. Also, within the compilation process, an output scheme corresponds to a set including: 1) an identifier to distinguish the output scheme from other output schemes, 2) a routing scheme, 3) a transpilation scheme, and optionally 4) a build executable. The transpilation scheme is a program used to translate an analyzed tree to a server-specific and client-specific language. The optional build executable is an executable program to compile transpiled source code. The compilation process takes as input: 1) a source stream, and 2) a set of output modes.

The compilation process of FIG. 1 begins with an operation 101 in which Space code is received as input by the Fusi compiler. In some embodiments, the Space code is received by the Fusi compiler in the format of a source stream. The compilation process then proceeds with an operation 103 for lexing of the Space code. In operation 103, the Space code is received as a source stream input by a lexer module. The lexer module operates to tokenize the Space code, in which the Space code is converted into a series of tokens. The lexer module operates to output the tokenized Space code as a token stream. The lexer module is configured to covert a text source of a text file into a stream of “tokens” using a lexicographical analyzer. In some embodiments, the lexicographical analyzer is the Flex lexicographical analyzer. However, in other embodiments, different lexicographical analyzers can be utilized by the lexer module to convert the Space code into the token stream as output by the lexer module. The lexicographical analyzer operates to match a string of source code, i.e., of Space code, against a series of regular expressions. When a string of source code is found to match a regular expression, a corresponding token is generated. Also, when two or more strings of source code are found to match regular expressions, the corresponding token that is generated is given a higher priority.

The compilation process then proceeds with an operation 105 for parsing the token stream output by the lexer module. The parsing of operation 105 is performed by a parsing module. The token stream as generated and output by the lexer module in operation 103 is received as input by the parsing module. The parsing module operates to generate and output an abstract syntax tree (AST). The AST is a tree representation of the abstract syntactic structure of the source code (Space code) including nodes representing language constructs. The parsing module is configured to match the incoming series of tokens against a grammar to produce a Parse Tree. In some embodiments, the parsing module is configured to use the Bison parser to express the grammar. However, in other embodiments, the parsing module can implement other parsers to generate and output the AST. During operation of the parsing module, after a token is matched to a leaf in the Parse Tree, the parsing module can optionally create a new AST node.

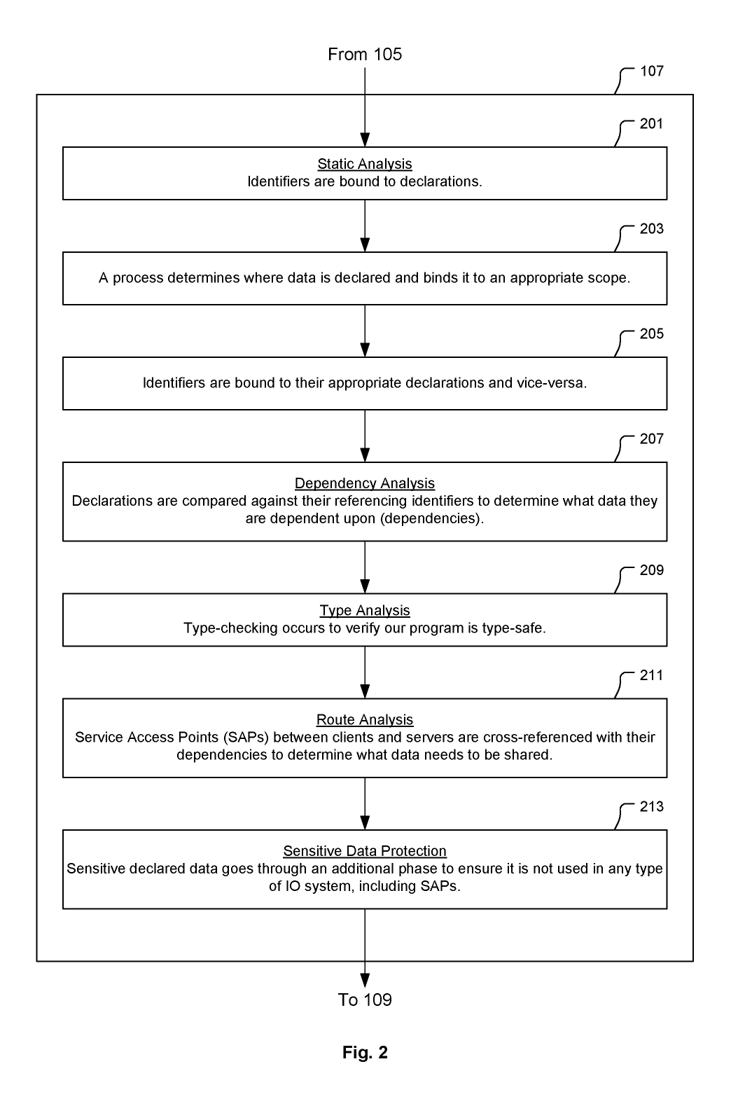

The compilation process then proceeds with an operation 107 in which lexical analysis is performed on the AST as output by the parsing module in operation 105. In the lexical analysis of operation 107, multiple phases of analysis occur to gather information regarding data an processes expressed within the application as represented by the source code (Space code). FIG. 2 shows a flowchart of the lexical analysis operation 107, in accordance with various embodiments of the present invention. The lexical analysis of operation 107 is implemented by a lexical analysis module. The lexical analysis of operation 107 begins with an operation 201 in which identifiers are bound to declarations. In the lexical analysis, a declaration is a data structure that is bound to an identifier and a collection of declarations. The declarations can be nested into a hierarchy in which declarations of child nodes within the hierarchy have “scope” to declarations of their parent nodes within the hierarchy. The nested hierarchy of declarations represents a declaration tree.

Following the operation 201, the lexical analysis continues with an operation 203 for performing declaration analysis on the AST as output by the parsing module in operation 105. In this sense, the AST output by the parsing module in operation 105 is the input of the declaration analysis of operation 203. The declaration analysis of operation 203 generates and outputs a declaration tree. The declaration tree is an AST in which a subset of nodes correspond with declarations. The declaration analysis of operation 203 is performed by a declaration analysis module, which may be a sub-module of the lexical analysis module. In the declaration analysis of operation 203, the input AST (from the parsing of operation 105) is traversed in search of memory-demand-nodes representing points in an application where memory will potentially need to be reserved. When a memory-demand-node is found, a corresponding declaration is created. The created declaration includes declarations nested lower in the AST, if any. Within the declaration tree, the outermost declaration, i.e., the declaration that does not have a parent node declaration within the hierarchy, corresponds to the top of the AST and includes all other declarations.

From the operation 203, the lexical analysis continues with an operation 205 for performing a reference analysis in which identifiers are bound to their appropriate declarations and vice-versa. The reference analysis of operation 205 is performed by a reference analysis module, which may be a sub-module of the lexical analysis module. The reference analysis takes as inputs: 1) the AST as output by the parsing module in operation 105, and 2) the declaration tree as output by the declaration analysis of operation 203. The reference analysis of operation 205 generates and outputs a reference tree. The reference tree as output by operation 205 is a declaration tree in which each declaration is bound to a collection of references. Each collection of references can include one or more references. Within the context of the reference analysis and the reference tree, a reference is an AST identifier node matched to a declaration. In some embodiments, the reference analysis of operation 205 includes matching of identifiers to declarations using a lexical scoping pattern. In the reference analysis, an identifier is matched against declarations within the identifier's containing scope or within one of the identifier's containing scope's parents. When an identifier is matched to a given declaration, the identifier is referred to as a reference of the given declaration. If no match is found between an identifier and a declaration, an error message is issued and the compilation process stops.

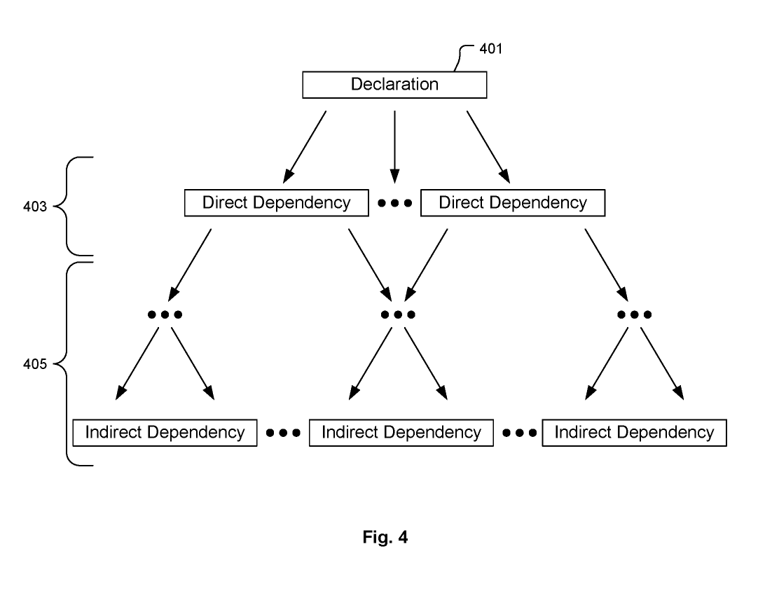

From the operation 205, the lexical analysis continues with an operation 207 for performing a dependency analysis in which declarations are compared against their referencing identifiers to determine what data they are dependent upon, i.e., to determine their dependencies. The dependency analysis of operation 207 is performed by a dependency analysis module, which may be a sub-module of the lexical analysis module. The dependency analysis takes as inputs: 1) the declaration tree as output by the declaration analysis of operation 203, and 2) the reference tree as output by the reference analysis of operation 205. The dependency analysis of operation 207 generates and outputs a dependency tree. Within the context of the dependency analysis, a dependency is a declaration with a nested declaration including a reference to the outer declaration. The outer declaration is considered a dependency of the inner declaration. The dependency tree as output by the dependency analysis is a reference tree in which each declaration is bound to a collection of dependencies. FIG. 4 shows an example dependency tree layout in which a declaration 401 is bound to a collection of dependencies that includes dependencies 403 and 405, where the dependencies 403 are direct dependencies from the declaration 401 and the dependencies 405 are indirect dependencies from the declaration 401.

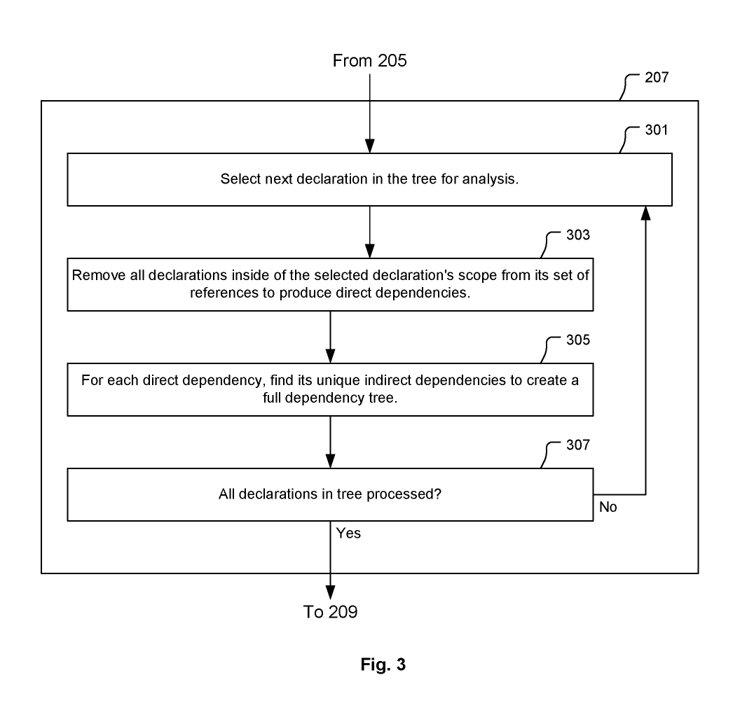

FIG. 3 shows an example of the dependency analysis of operation 207, in accordance with some embodiments of the present invention. The dependency analysis of operation 207 includes an operation 301 in which a next declaration in the declaration tree (as received as input to the dependency analysis) is selected for analysis to determine its dependencies. From the operation 301, an operation 303 is performed to determine direct dependencies for the currently selected declaration. Operation 303 includes removing all declarations inside of the currently selected declaration's scope from the currently selected declaration's set of references to identify the direct dependencies of the currently selected declaration. For example, in operation 303, when a Declaration A's scope contains a reference to Declaration B, and Declaration B is not contained by Declaration A's scope, then Declaration B is considered a direct dependency of Declaration A. The direct dependencies identified in operation 303 are recorded in the dependency tree for the currently selected declaration.

From the operation 303, an operation 305 is performed to determine all unique indirect dependencies for each direct dependency as identified in operation 303. For example, in operation 305, if Declaration B is a dependency of Declaration A, then all dependencies of Declaration B are also dependencies of Declaration A. This pattern of dependency is called indirect dependency. In this manner, Declaration A cannot be declared without Declaration B. The unique indirect dependencies identified in operation 305 are recorded in the dependency tree for the currently selected declaration. From the operation 305, an operation 307 is performed to determine if all declarations in the declaration tree (as received as input to the dependency analysis) have been processed through the dependency analysis. If operation 307 determines that at least one declaration in the declaration tree has not been processed through the dependency analysis, the method reverts back to operation 301. If operation 307 determines that all declarations in the declaration tree have been processed through the dependency analysis, the dependency analysis of operation 207 is completed and the resulting dependency tree is provided as output from the dependency analysis module.

From operation 207, the lexical analysis continues with an operation 209 for performing a type analysis in which type-checking is performed to verify that the application program corresponding to the source code (Space code) is type-safe. The type analysis of operation 209 is performed by a type analysis module, which may be a sub-module of the lexical analysis module. The type analysis takes as an input the declaration tree as output by the declaration analysis of operation 203. The type analysis of operation 209 generates and outputs a type tree. A type is a classification of data describing its potential structure and behavior. Types are used to identify conflicts in a program and notify developers of category errors. For example, a developer could mistakenly assign data of Type X to an identifier with explicit Type Y, thus causing a type conflict. As another example, a developer could mistakenly call a routine “substring” from an object with type “Boolean,” where type “Boolean” does not have the routine “substring,” thus causing a type conflict. A mixed-type is a type formed through a disjunction of types. A multi-type is a type formed through a conjunction of types.

The type analysis of operation 209 examines all declarations, references, and their respective AST nodes to determine all possible states of each node. The possible states of each declaration constitute a type for that declaration. A declaration can have an explicit type specified through the native programming language. Or, the declaration can have a type that is inferred from actions performed on references to the declaration elsewhere in the application. If multiple types are inferred for a declaration, the declaration has a mixed-type. In the type analysis of operation 209, each time a change in type occurs, the type analysis of operation 209 restarts. In this manner, the type analysis of operation 209 continues until no new information can be gathered.

From operation 209, the lexical analysis continues with an operation 211 for performing a route analysis in which service access points (SAPs) between clients and servers are cross-referenced with their dependencies to determine what data needs to be shared. The route analysis of operation 211 is performed by a route analysis module, which may be a sub-module of the lexical analysis module. The route analysis takes as an input the type tree as output by the type analysis of operation 209. The route analysis of operation 211 generates and outputs a routing tree, which is a type tree in which each declaration is bound to a set of SAPs.

Within the context of the route analysis, an environment refers to a subset of client or server machines that potentially interface with the application. In some embodiments, environments fall under one of the following categories: 1) server, 2) client, 3) server and client, 4) custom subset of clients, 5) custom subset of servers, 6) custom subset of servers and clients, and 7) ambiguous. Within the context of the route analysis, permissions refer to a set of flags detailing the environments to which a declaration may be transferred. In some embodiments, permissions fall under the following categories: 1) server, 2) client, 3) server and client, 4) custom subset of clients, 5) custom subset of servers, and 6) custom subset of servers and clients. Within the context of the route analysis, the SAP is a point in an application where logic is designated to execute on a subset of environments. To execute this logic, all dependent data is expected to be either already present in the environment or transferred to the environment. Data is transferred between environments under one of the following categories: 1) server-to-client, 2) client-to-server, 3) server-to-server, and 4) client-to-client. Within the context of the route analysis, a service load point (SLP) is an SAP where a new environment will be initialized.

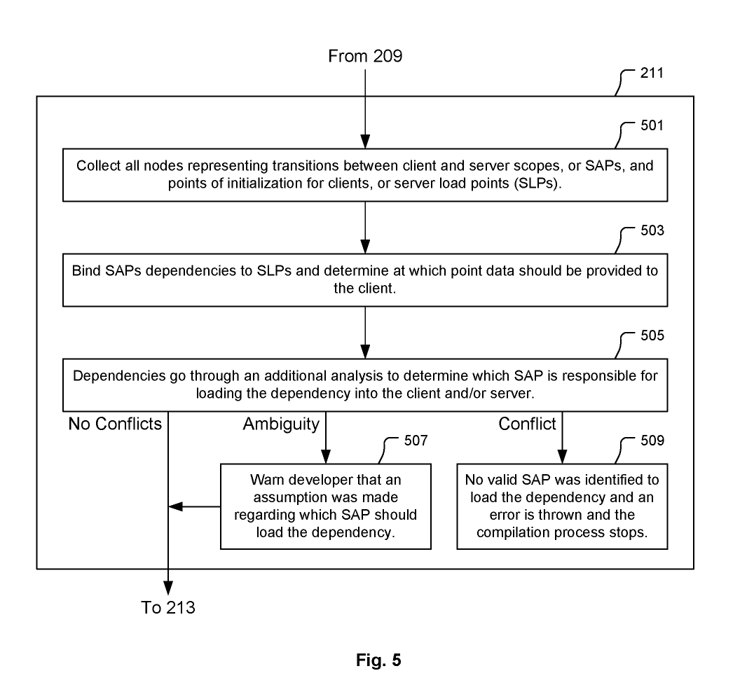

The route analysis of operation 211 examines the dependencies of each declaration and determines what data and/or functionality is required in which client and/or server environments at different states of the application. FIG. 5 shows a flowchart of the route analysis of operation 211, in accordance with various embodiments of the present invention. The route analysis begins with an operation 501 for collecting all nodes representing transitions between client and server scopes, or SAPs, and points of initialization for clients, or SLPs. All SLPs are distinguished from SAPs. An SLP can be specified explicitly or can be inferred from SAPs that have no SLPs executed prior to them. Following the operation 501, an operation 503 is performed to bind all SAPs to potential SLPs and their dependencies. Operation 503 also includes determination of which SAP is responsible for loading the dependency into the client and/or server.

An operation 505 is also performed to further process dependencies to determine which SAP is responsible for loading the dependency into the client and/or server. If operation 505 completes without any conflicts or ambiguity with regard to which SAP is responsible for loading each dependency, the route analysis of operation 211 is completed and the resulting routing tree is provided as output from the route analysis module. If no valid SAP can be identified to load the dependency in operation 505, an operation 509 is performed to issue a corresponding error message and the compilation process is stopped. If there is ambiguity in determining which SAP is to load a given dependency in operation 505, an operation 507 is performed to issue a warning that an assumption had to be made regarding which SAP is to load the given dependency. Following the operation 507, the route analysis of operation 211 is completed and the resulting routing tree is provided as output from the route analysis module.

Within the route analysis of operation 211, dependencies of SAPs are cross-referenced against their SAPs and SLPs to determine points of transfer. The choice of transfer depends on the dependency's type. If a decision cannot be made with regard to determining points of transfer, whether due to there being multiple valid choices or zero valid choices, an error is issued. By examining a given declaration's SAPs, the given declaration falls under a certain category of environments. If the declaration's environment filter is not compatible with its permissions, an error is issued and the compilation process stops. If the permission is a “custom subset” category, then the environment category is made to match the “custom subset” category. Conflicts between permission and environment can occur as follows:

1) server Permission, but client environment;

2) client permission, but server environment;

3) server and client permission, but ambiguous environment;

4) custom subset of servers permission, but either client environment or server environments outside of the custom subset's criteria;

5) custom subset of clients permission, but either server environment or client environments outside of the custom subset's criteria;

6) custom subset of servers and clients permission, but either ambiguous environment, or client environments outside of the custom subset's criteria, or server environments outside of the custom subset's criteria.

Each output scheme uses its own strategy to determine points of transfer. These strategies are implemented using an API exposing the routing tree as generated by the route analysis of operation 211. These implementations can be specified internally or externally.

From operation 211, the lexical analysis continues with an operation 213 for performing a sensitive data protection analysis in which sensitive declared data goes through an additional verification phase to ensure it is not used in any type of input/output system, including SAPs. The sensitive data protection analysis of operation 213 is performed by a sensitive data protection analysis module, which may be a sub-module of the lexical analysis module. The sensitive data protection analysis takes as an input the routing tree as output by the route analysis of operation 211. Within the context of the sensitive data protection analysis of operation 213, an input/output (IO) point corresponds to a point at which data will enter or exit the program at runtime. Within the context of the sensitive data protection analysis of operation 213, a foreign access point corresponds to a referencing of a foreign declaration, such as a function call on a foreign data. Within the context of the sensitive data protection analysis of operation 213, an exposure point corresponds to a node in a routing tree that falls under one or more of the following categories: 1) IO point, 2) foreign access point, and 3) service access point.

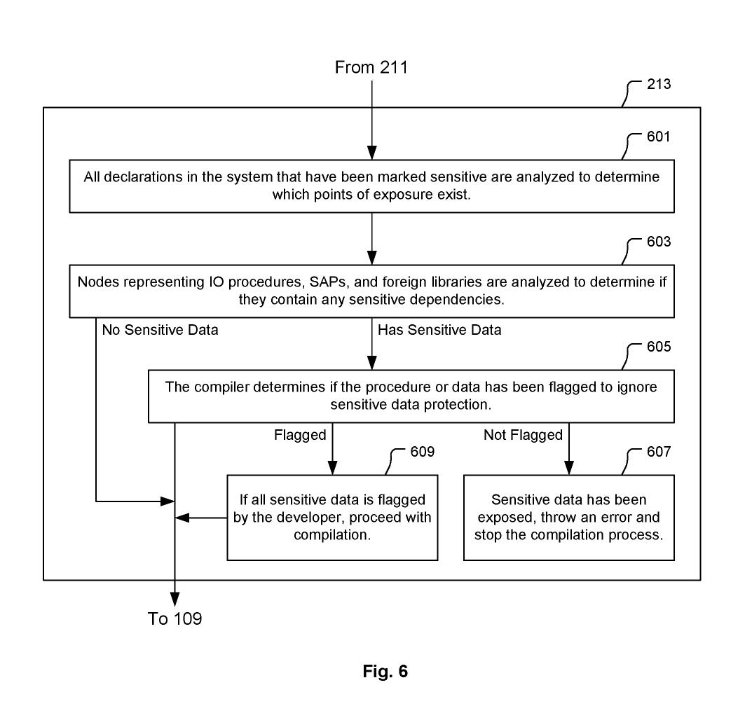

FIG. 6 shows a flowchart of the sensitive data protection analysis of operation 213, in accordance with various embodiments of the present invention. The sensitive data protection operation 213 begins with an operation 601 in which all declarations in the system that have been marked sensitive are analyzed to determine and identify the existence of any points of exposure of the sensitive-marked declarations. Then, an operation 603 is performed to analyze nodes representing IO procedures, SAPs, and/or foreign libraries to determine if they include any sensitive dependencies. If operation 603 determines that sensitive data is present, an operation 605 is performed to determine if the procedure or data has been flagged to ignore sensitive data protection. If operation 605 determines that the procedure or data has not been flagged to ignore sensitive data protection, an operation 607 is performed to issue an error message indicating that sensitive data has been exposed, and the compilation process stops. In this manner, if any exposure point has a dependency that has been marked as “sensitive,” and the exposure point has not been explicitly marked as “secure,” an error message notifies the developer of the dependency and exposure points, and the complication process stops.

With reference back to operation 605, if it is determined that the procedure or data has been flagged to ignore sensitive data protection, an operation 609 is performed to determine if all sensitive data has been flagged by the developer. If operation 609 determines that all sensitive data has been flagged by the developer, the sensitive data protection analysis of operation 213 is completed. With reference back to operation 603, if it is determined that no sensitive data has been detected as being exposed, the sensitive data protection analysis of operation 213 is completed, and the lexical analysis of operation 107 is completed.

Following completion of the lexical analysis of operation 107, the compilation process proceeds with an operation 109 for transpilation in which the fully analyzed AST is translated to a plurality of output sources. The transpilation of operation 109 is performed by a transpilation module. The transpilation takes as an input the routing tree as output by the routing analysis of operation 211, and an identification of a target server, and an identification of a target client. The transpilation of operation 109 generates and outputs target server source files and target client source files for the application corresponding to the Space code as input to the Fusi compiler. In the transpilation of operation 109, the AST is translated to a plurality of target machines and/or languages specified at the start of compilation. Each target machine and/or language uses a unique transpilation algorithm. The transpilation algorithm can be internal or externally specified according to an application programming interface (API) written in a source file in the native language.

From the transpilation operation 109, the compilation process proceeds with an operation 111 for building of the server application and the client application corresponding to the Space code as input to the Fusi compiler. The building of operation 111 is performed by a build module. The building takes as input the target server source files and the target client source files as output by the transpilation of operation 109, along with the identification of the target server, and the identification of the target client. The building of operation 111 generates and outputs the server application for the target server and the client application for the target client. In some embodiments, a target machine of the build operation 111 may correspond to an external executable program used to further compile source text as output from the transpilation operation 109. The output of the build operation 111 is the final compilation results of the compilation process. The output of the build operation 111 is a set of files read for execution by the target client device and a set of files ready for execution by the target server device.

It should be understood that the compilation process of FIG. 1 provides exposure protection. The potential path of every variable in an application is calculated and stored. In addition, all SAPs within an application are calculated and stored. A variable can be flagged to prevent it from passing through a category of SAP.

Also, it should be understood that the compilation process of FIG. 1 provides cross-site scripting protection. All potential SAPs in an application are calculated and stored. Client and server logic concerned with passing data through these points is generated during the transpilation process. This logic can be guaranteed to prevent the execution of arbitrary server logic. This reduces the possibility of malicious cross-site scripting attacks. Additionally, logic can be included at these SAPs to filter inputs and outputs based on an expected format.

Also, it should be understood that the compilation process of FIG. 1 provides client logic protection. The transpilation process can obfuscate resulting client-specific application source. This helps prevent the deciphering and manipulation of a client and its related Server APIs.

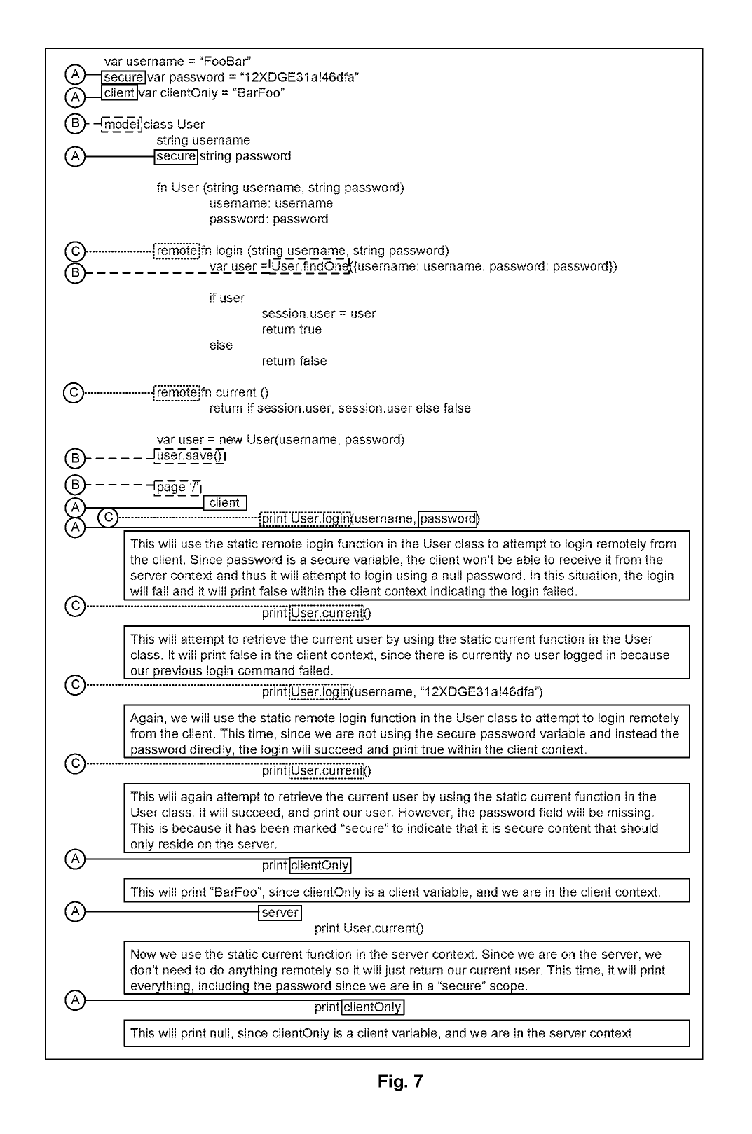

The native language (Space code) uses a unique indent-based syntax designed to express all layers of the common web stack including: 1) modeling data for a database, 2) traditional declarative programming logic, 3) routing client and server procedures, and 4) layout out a hierarchy of graphical view components such as HTML and CSS. FIG. 7 shows an example of native language (Space code), in accordance with various embodiments of the present invention. With regard to reference “A” in FIG. 7, within the Fusi compilation platform (FIG. 1) and Space language environment, there is a lexical scope as well as a server and client scope. The server and client scope works lexically. However, it functions differently as it provides an abstraction to create a shared scope between two completely different environments. This in turn allows the Fusi compilation platform and Space language to be considered a full-stack programming language and platform, since developers can simultaneously program client and server logic within the same code. More importantly, it allows for reservation of data and logic for particular scopes, using keywords such as “secure,” “server,” and “client.” By marking data as “secure” or “server,” the Fusi compiler knows that those particular sets of data cannot be shared with clients. Secure analysis and processing takes further steps and ensures that it is not used in any type of IO related procedures.

With regard to reference “B” in FIG. 7, the Fusi compilation platform also introduces a native model view controller (MVC) pattern into the language itself. This allows developers to dynamically model data to be saved to a database, as well as create custom routes and pages for use cross-platform. With regard to reference “C” in FIG. 7, extending client and server abstraction, a remote procedural call (RPC) modifier is provided, “remote,” which allows for use of functions on the client that perform server routines. These functions can also return some data back to the client to potentially be used in a client routine. When used in the server context, these functions will perform normally since we are already in the server environment. In this manner, “secure” and “server” data will be filtered from returned data when called from the client.

The following outline summarizes the compilation process described above with regard to FIGS. 1 through 6.

### Compilation Outline

1. Terminology
a. Source Stream—A string of characters
b. Output Scheme—A set containing:
   i. An identifier to distinguish this output scheme from other Output Schemes,
   ii. Routing Scheme,
   iii. Transpilation Scheme—A program used to translate the analyzed tree to a server-specific and client-specific language,
   iv. Build Executable (OPTIONAL)—An executable program to compile Transpiled source code.

2. Input
a. Source Stream
b. A set of Output Modes

3. Lexing
a. Input
   i. Source Stream
b. Output
   i. Token Stream
c. Description
   i. A text source or a text file is converted into a stream of “Tokens” using a Lexicographical Analyzer called “Flex”. A string of source code is matched against a series of regular expressions. When a match is found, a token is produced. When two or more matches are found at the same time, the longer match is prioritized.

4. Parsing
a. Input
   i. Token Stream
b. Output
   i. Abstract Syntax Tree
c. Description
   i. A series of tokens is matched against a grammar producing a Parse Tree. A Parser called “Bison” is used to express a grammar. After a token is matched to a leaf in the Parse Tree, it optionally creates a new Abstract Syntax Tree node.

5. Lexical Analysis
a. Declaration Analysis
   i. Terminology
      Declaration—A data structure bound to an identifier and a collection of Declarations. The nested Declarations form a hierarchy where child nodes' Declarations are said to have “scope” to their parent nodes' Declarations.
      Declaration Tree—An Abstract Syntax Tree in which a subset of nodes correspond with Declarations.
   ii. Input
      Abstract Syntax Tree
   iii. Output
      Declaration Tree
   iv. Description
      The AST is traversed in search of nodes representing points in an Application where memory will potentially have to be reserved. When such a node is found a Declaration is created containing Declarations nested lower in the AST, if any. The outermost Declaration corresponds to the top of the AST and contains all the other Declarations. This structure is referred to as a “Declaration Tree”
b. Reference Analysis
   i. Terminology
      Reference—An AST Identifier node matched to a Declaration
      Reference Tree—A Declaration Tree where each Declaration is bound to a collection of References
   ii. Input
      Abstract Syntax Tree
      Declaration Tree
   iii. Output
      Reference Tree
   iv. Description
      Identifiers are matched to a Declaration according to a lexical scoping pattern. That is, an Identifier will be matched against Declarations within the Identifier's containing Scope or one of the Scope's parents. When an identifier is matched to a Declaration, the Identifier is referred to as a “Reference” of said Declaration. If no match is found an error is thrown and compilation ceases.
c. Dependency Analysis
   i. Terminology
      Dependency—A Declaration with a nested Declaration containing a Reference to the outer Declaration. The outer Declaration is said to be a Dependency of the inner Declaration.
      Dependency Tree—A Reference Tree where each Declaration is bound to a collection of Dependencies.
   ii. Input
      Declaration Tree
      Reference Tree
   iii. Output
      Dependency Tree
   iv. Description
      When a Declaration A's Scope contains a Reference to Declaration B and Declaration B is not contained by Declaration A's Scope, then Declaration B is considered an “Direct Dependency” of Declaration A.
      If Declaration B is a Dependency of Declaration A, then all Dependencies of Declaration B are also Dependencies of Declaration A. This pattern of Dependency is called “Indirect Dependency”
      This means Declaration A cannot be declared without Declaration B.

6. Type Analysis
a. Terminology:
   i. Type—A classification of data describing its potential structure and behavior. Types are used to identify conflicts in a program and notify developers of category errors. For example:
      A developer could mistakenly assign data of Type X to an identifier with explicit Type Y
      A developer could mistakenly call routine “substring” from an object with Type “Boolean” which has no such routine.
   ii. Mixed Type—A Type formed through a disjunction of Types
   iii. Multi Type—A Type formed through a conjunction of Types
b. Input
   i. Declaration tree
c. Output
   i. Type Tree—A Tree Structure representation
d. Description
   i. This process examines all Declarations, References, and their respective AST nodes to determine all possible states of each node. The possible states of each Declaration constitute a Type for that Declaration.
   ii. A Declaration can have an explicit Type specified through the native language or it can be inferred from actions performed on References to the Declaration elsewhere in the application. If multiple Types are inferred for a Declaration, the Declaration has a Mixed Type.
   iii. Each time a change in Type occurs the Type Analysis process restarts. This means the process will continue until no new information can be gathered.

7. Route Analysis
a. Terminology
   i. Environment—A subset of Client or Server machines potentially interfacing with an Application. Environments fall under one of the following categories:
      Server
      Client
      Server & Client
      Custom subset of Clients
      Custom subset of Clients
      Custom subset of Servers & Clients
      Ambiguous
   ii. Permissions—A set of flags detailing which Environments a Declaration may be transferred to. Permissions fall under the following categories:
      Server
      Client
      Server & Client
      Custom subset of Servers
      Custom subset of Clients
      Custom subset of Servers & Clients
   iii. Service Access Point (SAP)
      A point in an Application where logic is designated to execute on a subset of Environments. To execute this logic, all Dependent data must either be already present in the Environment or transferred to the Environment. Data is transferred between Environments under one of the following categories:
         Server to Client
         Client to Server
         Server to Server
         Client to Client
   iv. Service Load Point (SLP)
      A Service Access Point where a new Environment will be initialized.
   v. Routing Tree
      A Type Tree where each Declaration is bound to a set of Service Access Points
b. Input
   i. Type Tree
c. Output
   i. Routing Tree
d. Description
   i. This stage looks at the dependencies of each Declaration and determines what data and/or functionality is required in which Client and Server Environments at different states of the application.
   ii. All SLP's are distinguished from SAP's. SLP's can be specified explicitly or can be inferred from SAP's that have no SLP's executed prior to them.
   iii. All SAP's are then bound to all potential SLPs and their Dependencies.
   iv. Dependencies of SAPs are cross-referenced against their SAPs and SLPs to determine points of transfer. This choice of transfer depends on the Dependency's Type. If a decision can not be made, whether due to there being multiple valid choices or zero valid choices, an error is thrown.
   v. By looking at its SAPs, each Declaration falls under a certain category of Environments. If the Declaration's Environment Filter is not compatible with its Permissions, an error is thrown and compilation ceases. If the Permission is a “custom subset” category then the Environment category must match it. Conflicts between Permission and Environment can occur as follows:
      Server Permission:
         Client Environment
      Client Permission:
         Server Environment
      Server & Client Permission:
         Ambiguous Environment
      Custom subset of Servers Permission:
         Client Environment, or
         Server Environments outside of the Custom subset's criteria.
      Custom subset of Clients Permission:
         Server Environment, or
         Client Environments outside the Custom subset's criteria
      Custom subset of Servers & Clients Permission:
         Ambiguous Environment, or
         Client Environments outside of the Custom subset's criteria, or
         Server Environments outside of the Custom subset's criteria.
   vi. Each Output Scheme uses its own strategy to determine points of transfer. These strategies are implemented using an API exposing the Routing Tree. These implementations can be specified internally or externally.

8. Security Analysis
a. Terminology
   i. IO Point—A point at which data will enter or exit the program at runtime
   ii. Foreign Access Point—A referencing of a Foreign Declaration, such as a function call on a foreign data
   iii. Exposure Point—An node in a Routing Tree falling under one or more of the following categories:
      IO Point
      Foreign Access Point
      Service Access Point.
b. Input
   i. Routing Tree
c. Description
   i. If any Exposure Point has a Dependency that has been marked as “sensitive” and the Exposure Point has not been explicitly marked as “secure”, an error message notifies the developer of the Dependency and Exposure Points and Compilation ceases.

9. Transpilation
a. Input
   i. Routing Tree
   ii. Server target
   iii. Client target
b. output: server target source files, client target source files
c. description:
   i. The AST is translated to a plurality of Target Machines and/or languages specified at the start of Compilation.
   ii. Each target machine and/or language uses a unique transpilation algorithm. This algorithm can be internal or externally specified according to an API written in a source file in the native language.

10. Build
a. input: server source files, client source files, server target, client target
b. output: server application, client application
c. description:
   i. A Target Machine may correspond to an external executable program used to further compile source text output from Transpilation. This final compilation results in a set of files ready to be executed by a Client Device and a set of files ready to be executed by a Server Device.

11. Security
Exposure Protection
   The potential path of every variable in an application is calculated and stored. In addition, all Service Access Points within an application are calculated and stored. A variable can be flagged to prevent it from passing through a category of Service Access Point.
Cross-Site Scripting Protection
   All potential Service Access Points in an Application are calculated and stored. Client and Server logic concerned with passing data through these points is generated during the transpilation process. This logic can be guaranteed to prevent the execution of arbitrary server logic. This reduces the possibility of malicious Cross-Site Scripting attacks. Additionally, logic can be included at these Service Access Points to filter inputs and outputs based on an expected format.
Client Logic
   The transpilation process can obfuscate resulting client-specific application source. This helps prevent the deciphering and manipulation of a client and its related Server APIs.

12. Syntax

The Native Language uses a unique indent-based syntax designed to express all layers of the common web stack including:
1. Modeling data for a database
2. Traditional declarative programming logic
3. Routing Client & Server procedures
4. Laying out a hierarchy of graphical view components such as HTML & CSS.

A single input source is compiled into multiple lower level sources for one or more servers, clients, databases and other machines. The lower level sources may be specific to the underlying server and client platforms. The compiler simplifies the creation of multiple output source compatibility by abstracting a communication protocol mechanism. By using abstraction for the communication protocol, the present system provides a programming language and allows developers to create applications abstracting away from underlying complexity. A new unified programming language that abstracts communication protocols decreases the complexity of developing web pages.

In some embodiments, a method includes receiving an input source by a compiler. The input source may include an abstraction of communication protocols between a plurality of output sources. The input source may be compiled into a plurality of output sources by the compiler. At least one of the plurality of output sources may include communication protocols for communicating with at least one other output source. A first output source of the plurality of output sources may be provided to a remote machine to be executed.

In some embodiments, a system for establishing a connection may include a server in communication with a user client device. The server may include a processor, memory, and one or more applications stored in memory at the server and executable by the processor to receive an input source, the input source including an abstraction of communication protocols between a plurality of output sources, compile the input source into a plurality of output sources, at least one of the plurality of output sources including communication protocols for communicating with at least one other output source, and provide a first output source of the plurality of output sources to a remote machine to be executed.

A single input source is compiled into multiple lower level sources for one or more servers, clients, databases and other machines. The lower level sources may be specific to the underlying server and client platforms. The compiler simplifies the creation of multiple output source compatibility by abstracting a communication protocol mechanism. By using abstraction for the communication protocol, the present system provides a programming language and allows developers to create applications abstracting away from underlying complexity. A new unified programming language that abstracts communication protocols decreases the complexity of developing web pages.

The present compiler avoids the need to program two separate machines and the protocols between them separately from each other and aggregate the programs into libraries. Rather, grammar constructs are created as part of a programming language that provide functionality on a more primitive level. A developer may describe a single behavior and the compiler automatically determines what is needed in communication protocols and implements it for multiple sources that communicate using the protocols.

Though examples of a system using the compiler may be discussed as having a server and a client, this is for illustration purposes only and is not meant to be limiting. The compiler of the present technology may be used to provide output source for multiple servers, multiple clients, databases, web crawlers, and any number of other machines.

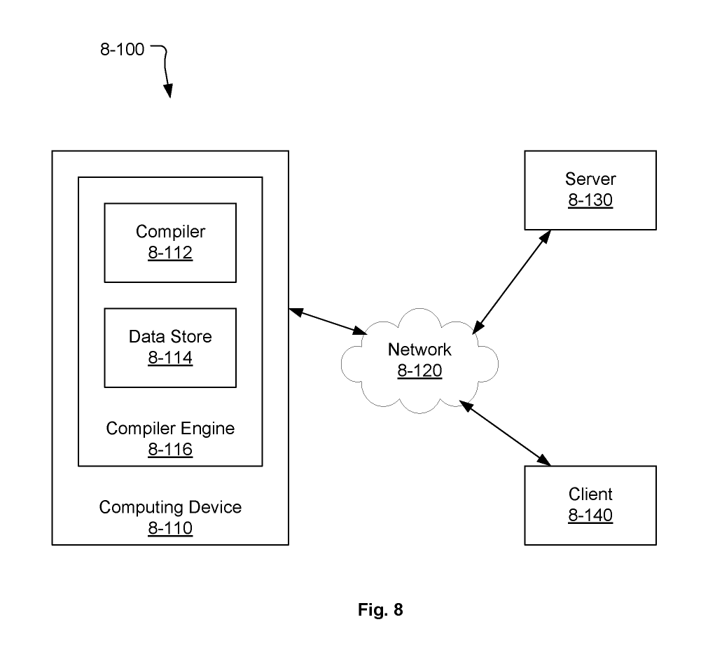

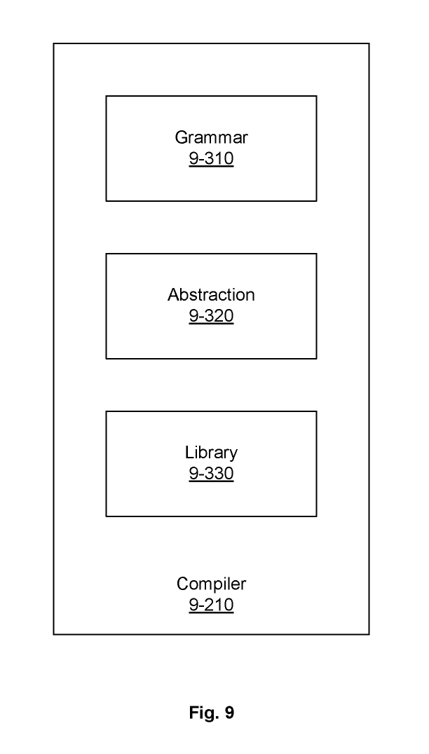

FIG. 8 illustrates a block diagram of a system for compiling code into multiple lower level sources. The system of FIG. 8 includes a computing device 8-110, network 8-120, server 8-130 and client 8-140. The computing device 8-110 may include a compiler engine 8-116 that includes a compiler 8-112 and data store 8-114. The compiler 8-112 may receive an input source and output multiple output sources for execution at a server, client and other machines as appropriate. Data store 8-114 may store a namespace created for an input source at compilation time and stores the namespace for use in future compilation and feature instructions. The computing device 8-110 and compiler 8-112 may provide a permanent Runtime environment with an incremental compilation process which compiles an input source once and later compilation instructions being placed on top of the first compilation, for example by replacing specific portions of later compiled code without affecting other code. Compiler 8-112 is discussed in more detail below with respect to FIG. 9.

The network 8-120 may communicate information between computing device 8-110, server 8-130 and client 8-140. The network 8-120 may include a local area network, wide area network, an intranet, the Internet, a private network, public network, cellular network, wireless network, and a combination of these networks.

Server 8-130 may provide a web service to clients such as client 8-140. Server 8-130 may receive compiled instructions from computing device 8-110 and execute the instructions to provide the web service over network 8-120. Server 8-130 may receive requests from client 8-140 and provide the client with instructions received from compiler 8-112.

FIG. 9 illustrates a block diagram of a compiler 9-210. Compiler 9-210 may translate its own language, including communication protocol abstractions, into one or more other languages consistent with source destination platforms. The compiler 9-210 may include grammar data 9-310, abstractions 9-320, and library 9-330. Grammar data 9-310 specifies grammar that provides abstraction to developers. For example, the grammar may include keywords, identifiers, and other tokens sufficient for expressing communication protocol abstractions. Keywords and tokens may delimit a scope, protocol, or function including math, data, logic, gate, loop, asynchronous, memory, and network functions. Identifiers may refer to variable data. For purposes of discussion, examples of grammar discussed herein may include declarators, operators and proclerators. These specific types of grammar are for exemplary purposes only, and it is within the scope of the invention to include other grammar with the present technology.

Declarators may be positioned at the beginning of an expression, before any operands, and may include modifiers, data, math, logic, gate, loop, asynchronous, request, response, and grammatical declarators. Operators may be placed proceeding an operand to form an expression and may include math, logic, comparison, conditional, iteration, data, list and assignment operators. Proclerators may be denoted at the end of an expression and may include math procleators.

Abstractions 9-320 may include rules and code that implement the protocols used for a specific set of output sources based on a received input source. The library 9-330 may include a collection of implementations of behavior which can be invoked by the grammar constructs.

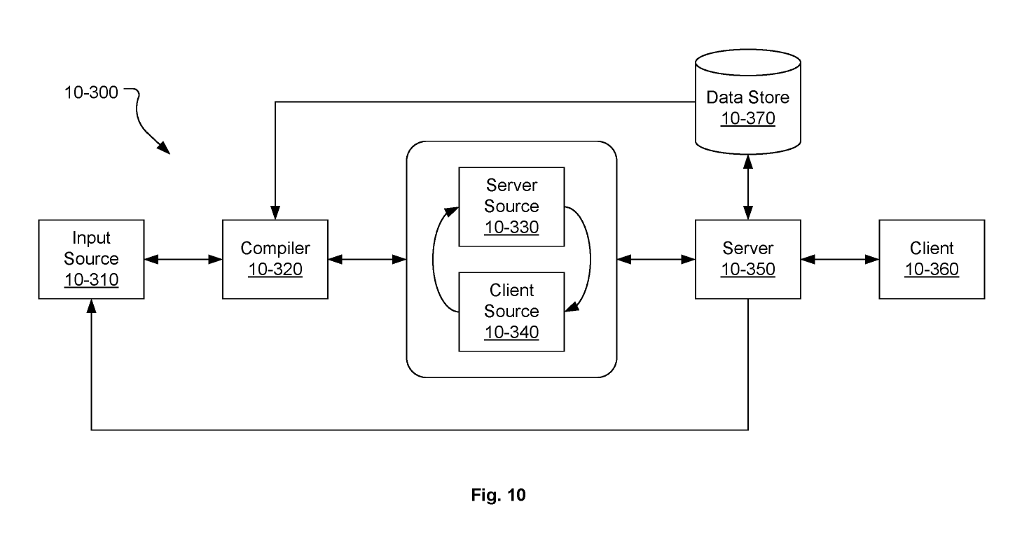

FIG. 10 illustrates a block diagram of a compiling process 10-300 utilizing communication protocol abstraction constructs. The process beings with compiler 10-320 receiving an input source 10-310. The compiler 10-320 generates a plurality of lower level source outputs, such as server source 10-330 and client source 10-340. The compiler 10-320 may receive data from data store 10-370, such as grammar, abstractions, and libraries, to generate the lower level sources. A first source code, such as for example a server source 10-330, is provided to a server 10-350 for initialization and execution. Upon request or another event, the server source code may provide an update such as client source 10-340 to client 10-360. When an update event is detected by server 10-350, the server provides details of the event to input source 10-310. A second input source related to a set of machines (i.e., particular server, client) may be provided to the compiler 10-320, which compiles the input source and adds the output to previous compilations for the set of machines.

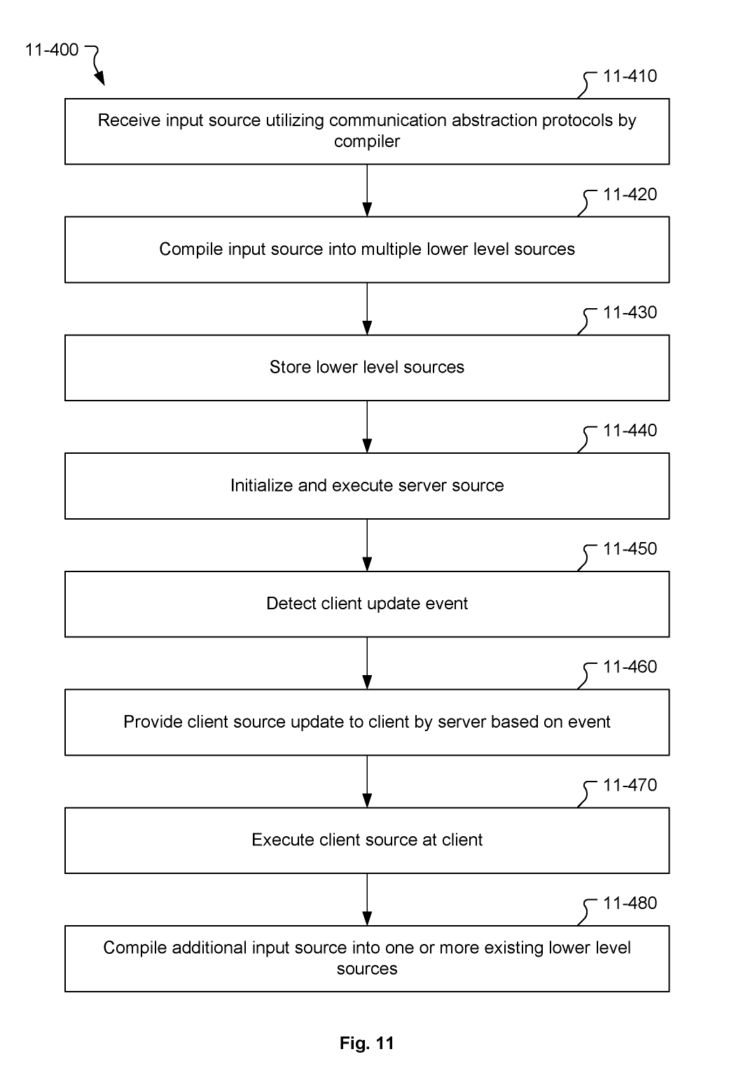

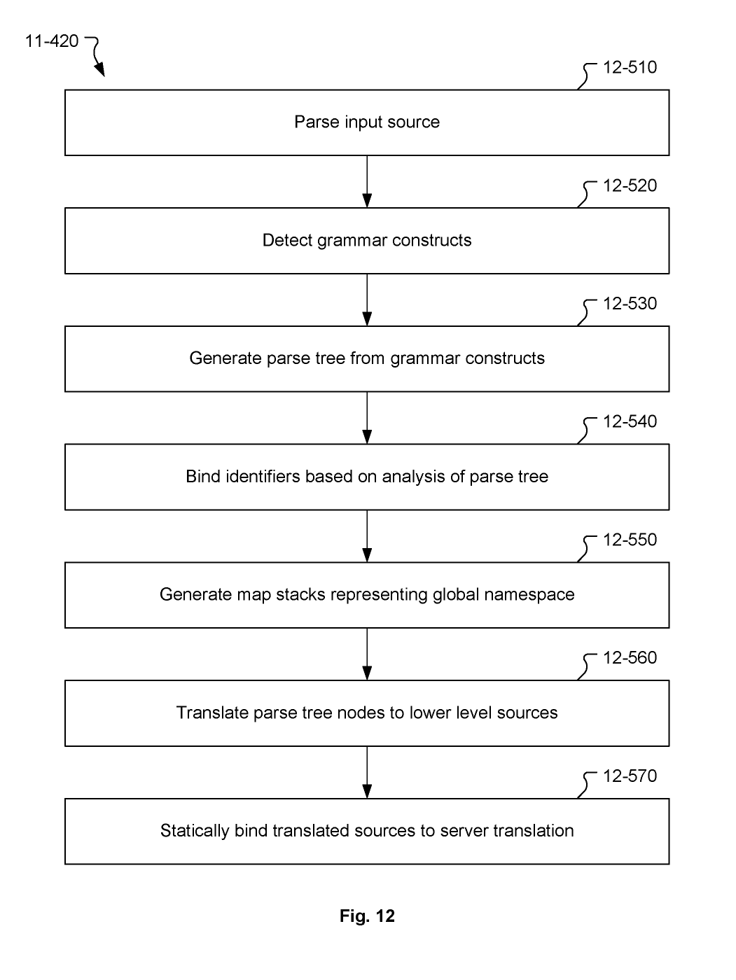

FIG. 11 illustrates a method 11-400 for compiling code into multiple lower level sources. An input source that utilizes communication abstraction protocols may be received by a compiler at step 11-410. The input source may then be compiled into multiple lower level sources at step 11-420. The compiler may include grammar, specific abstractions and standard libraries to provide multiple lower lever sources from a single input source. Compiling an input source is discussed with respect to FIG. 12.

Lower lever sources output from the compiler are stored at step 11-430. A server source or other source that is executed first may be provided to a server (or other machine at which it is to be executed) at step 11-440. The source is executed at the server and may begin to provide the effects programmed by the develop.

A client update event may be detected at step 11-450. A client update event may include any event that requires an output source to be provided to the client. For example, an event may include a client request for data, a push notification to the client, or some other event. A client source update is provided to the client by the server based on the event at step 11-460. The client source output may be provided to the server by the compiler, which provides the source to the client as needed. The client source may then be executed at the client at step 11-470.

Data may be transferred between a client and server without losing state or structure through marshalling. Objects may be marshalled before transfer and unmarshalled when received. The marshalling process may determine the object's type and dependencies which are used to restore state and behavior to the object once unmarshalled.

Additional input source may be compiled into one or more existing lower level sources at step 11-480. The additional input source compilation may overwrite individual identifiers and associated data in the namespace. As such, input source can be incrementally compiled and recompiled.

FIG. 12 illustrates a method for compiling code from an input having communication protocol abstraction constructs. The method of FIG. 12 corresponds to operation 11-420 of FIG. 11. The input source is parsed at step 12-510. The compiler may then detect grammar constructs in the parsed input at step 12-520 and generate a parse tree from the grammar constructs at step 12-530. Identifiers may be bound based on the parse tree analysis at step 12-540. Map stacks which represent the global namespace may be generated at step 12-550. Parse tree nodes are then translated to lower level sources at step 12-560. Translated sources may then be statically bound to a server translation at step 12-570.

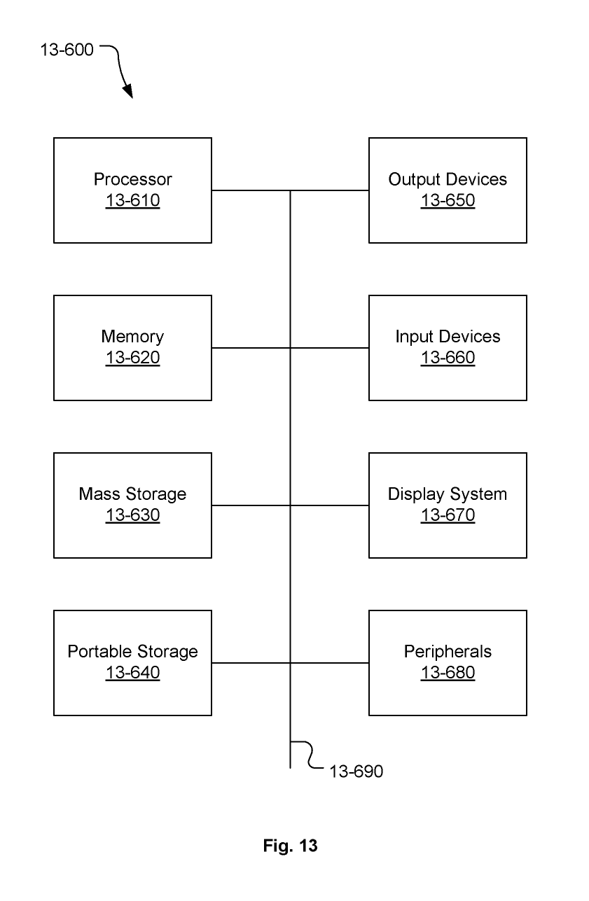

FIG. 13 is a block diagram of an exemplary system 13-600 for implementing a computing device. System 13-600 may be implemented in the contexts of the likes of computing device 8-110, server 8-130, and client 8-140. The computing system 13-600 includes one or more processors 13-610 and memory 13-620. Main memory 13-620 stores, in part, instructions and data for execution by processor 13-610. Main memory 13-620 can store the executable code when in operation. The system 13-600 further includes a mass storage device 13-630, portable storage medium drive(s) 13-640, output devices 13-650, user input devices 13-660, a graphics display 13-670, and peripheral devices 13-680.

The components shown in FIG. 13 are depicted as being connected via a single bus 13-690. However, the components may be connected through one or more data transport means. For example, processor unit 13-610 and main memory 13-620 may be connected via a local microprocessor bus, and the mass storage device 13-630, peripheral device(s) 13-680, portable storage device 13-640, and display system 13-670 may be connected via one or more input/output (I/O) buses.

Mass storage device 13-630, which may be implemented with a magnetic disk drive or an optical disk drive, is a non-volatile storage device for storing data and instructions for use by processor unit 13-610. Mass storage device 13-630 can store the system software for implementing embodiments of the present invention for purposes of loading that software into main memory 13-620.

Portable storage device 13-640 operates in conjunction with a portable nonvolatile storage medium, such as a floppy disk, compact disk or digital video disc, to input and output data and code to and from the computer system 13-600. The system software for implementing embodiments of the present invention may be stored on such a portable medium and input to the computer system 13-600 via the portable storage device 13-640.

Input devices 13-660 provide a portion of a user interface. Input devices 13-660 may include an alpha-numeric keypad, such as a keyboard, for inputting alpha-numeric and other information, or a pointing device, such as a mouse, a trackball, stylus, or cursor direction keys. Additionally, the system 13-600 includes output devices 13-650. Examples of suitable output devices include speakers, printers, network interfaces, and monitors.

Display system 13-670 may include a liquid crystal display (LCD) or other suitable display device. Display system 13-670 receives textual and graphical information, and processes the information for output to the display device.

Peripherals 13-680 may include any type of computer support device to add additional functionality to the computer system. For example, peripheral device(s) 13-680 may include a modern or a router.

The components contained in the computer system 13-600 are those typically found in computer systems that may be suitable for use with embodiments of the present invention and are intended to represent a broad category of such computer components that are well known in the art. Thus, the computer system 13-600 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The above-described systems, modules, interfaces, and processes have been described in technical form and detail to enable understanding of how the Fusi compiler system provides a source code compilation technique in which a source program written in a native programming language describing a relationship between a plurality of client and server machines is understood and processed to produce a plurality of client and server applications for a plurality of target devices. It will be obvious, however, to one skilled in the art, that the present invention may be practiced without some or all of these specific details. In other instances, well known process operations have not been described in detail in order not to unnecessarily obscure the present invention.

For these reasons, the present description should be viewed as exemplary and not limiting to any one example or description. To the contrary, it should be understood that some steps or operations described herein may be omitted, replaced, or joined to create single operations. In some cases, the code may be modified to expand functionality, which is consistent with the scope and spirit of the methods and systems described herein.

The various embodiments defined herein may define individual implementations or can define implementations that rely on combinations of one or more of the defined embodiments. Further, embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

In accordance with aspects of the disclosure, a plurality of devices, storage, and services that may be connected to network. The network can be, for example, the Internet. The Internet is interconnected with a plurality of devices, including cloud storage servers, cloud logic servers, user interface devices, etc. Some devices that can communicate with the Internet access services on various cloud logic servers and cloud storage can include, e.g., tablet computers, smart phones, connected watches, connected appliances, laptops, desktop computers, television systems, and the like. The devices that can communicate with each other require at least a processor. In some cases, devices will also include a display for presenting user interface views from selected programs and code that render the user interfaces. The user interface can be provided through keyboard entry, text entry, voice entry, gesture entry, and combinations thereof.

With the above embodiments in mind, it should be understood that the invention could employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced. Accordingly, the present embodiments are to be considered as illustrative and not restrictive, and the invention is not to be limited to the details given herein, but may be modified within the scope and equivalents of the description.

What is claimed is:

1. A method for compiling a program, comprising:
receiving an input source by a compiler, the input source including an abstraction of communication protocols between a plurality of output sources;
compiling the input source into a plurality of output sources by the compiler, at least one of the plurality of output sources including communication protocols for communicating with at least one other output source; and
providing a first output source of the plurality of output sources to a remote machine to be executed.

2. The method of claim 1, wherein compiling includes detecting grammar elements and automatically generating instructions for a communicating using a protocol specific to each of two or more of the two or more sources.

3. The method of claim 2, wherein the grammar elements includes declarators, operators, and proclerators.

4. The method of claim 3, wherein the grammar includes a combination of two or more declarators, operators, and proclerators within a single expression.

5. The method of claim 1, further comprising:
generating a single namespace for the plurality of output sources.

6. The method of claim 1, wherein the first output source is a server output source executed at a server.

7. The method of claim 6, further comprising:
providing a second output source of the plurality of output sources to a second computing device by the server.

8. The method of claim 1, further comprising:
receiving a second input source by the compiler; and
compiling the second input source and adding the output of the second input source compiling into one or more of the plurality of output sources.

9. A non-transitory computer readable storage medium having embodied thereon a program, the program being executable by a processor to perform a method for compiling a program, the method comprising:
receiving an input source by the compiler, the input source including an abstraction of communication protocols between a plurality of output sources;
compiling the input source into a plurality of output sources, at least one of the plurality of output sources including communication protocols for communicating with at least one other output source; and
providing a first output source of the plurality of output sources to a remote machine to be executed.

10. The non-transitory computer readable storage medium of claim 9, wherein compiling includes detecting grammar elements and automatically generating instructions for a communicating using a protocol specific to each of two or more of the two or more sources.

11. The non-transitory computer readable storage medium of claim 10, wherein the grammar elements includes keywords, identifiers, or other tokens sufficient for expressing communication protocol abstractions.

12. The non-transitory computer readable storage medium of claim 11, wherein the grammar includes a combination of two or more keywords, identifiers, or other tokens sufficient for expressing communication protocol abstractions within a single expression.

13. The non-transitory computer readable storage medium of claim 9, further comprising:
generating a single namespace for the plurality of output sources.

14. The non-transitory computer readable storage medium of claim 9, wherein the first output source is a server output source executed at a server.

15. The non-transitory computer readable storage medium of claim 14, further comprising:
providing a second output source of the plurality of output sources to a second computing device by the server.

16. The non-transitory computer readable storage medium of claim 9, further comprising:
receiving a second input source by the compiler; and
compiling the second input source and adding the output of the second input source compiling into one or more of the plurality of output sources.

17. A computing device for compiling a program, the device comprising:
a processor;
memory;
a compiler engine stored in memory and executable by the processor to receive an input source, the input source including an abstraction of communication protocols between a plurality of output sources, compile the input source into a plurality of output sources, at least one of the plurality of output sources including communication protocols for communicating with at least one other output source, and provide a first output source of the plurality of output sources to a remote machine to be executed.

18. The computing device of claim 17, wherein compiling includes detecting grammar elements and automatically generating instructions for a communicating using a protocol specific to each of two or more of the two or more sources.

19. The computing device of claim 18, wherein the grammar elements include keywords, identifiers, or other tokens sufficient for expressing communication protocol abstractions.

20. The computing device of claim 19, wherein the grammar elements include a combination of two or more keywords, identifiers, or other tokens sufficient for expressing communication protocol abstractions within a single expression.
